(19) United States
(12) Patent Application Publication
(10) Pub. No.: US 2008/0128954 A1
(43) Pub. Date: Jun. 5, 2008

(54) MAGNETIC BLOCKOUT

(75) Inventors: David S. Jablonsky, Manchester, CT (US); Ted Kegeris, Fairland, IN (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: JVI Magnetics, Inc., Fountaintown, IN (US)

(21) Appl. No.: 11/876,138

(22) Filed: Oct. 22, 2007

Related U.S. Application Data
(60) Provisional application No. 60/862,361, filed on Oct. 20, 2006.

(51) Int. Cl. B28B 17/00

(52) U.S. Cl. 264/426; 425/3

(57) ABSTRACT

A magnetic blockout assembly including a concrete barrier element having a front side, a back side and a cavity in the front side, at least one magnet embedded within the back side of the concrete barrier element, and a flange connector having an engagement surface sized and shaped to fit within the cavity of the concrete barrier element, so that the concrete barrier element may be coupled to the flange connector to position the flange connector in a predetermined location and protect a surface of the flange connector from concrete and other foreign substances.

### CROSS-REFERENCE TO RELATED APPLICATIONS

This application claims priority of U.S. Provisional Patent Application No. 60/862,361, filed Oct. 20, 2006, in the United States Patent and Trademark Office, the disclosure of which is incorporated herein by reference in its entirety.

### BACKGROUND OF THE INVENTION

1. Field of the Invention

The present general inventive concept relates to a magnetic blockout, and more particularly, to a magnetic blockout for use with a flange connector which is used to adjoin precast concrete structures.

2. Background of the Invention

In the construction industry, various known flange connectors are used as a sheer connection between precast concrete elements, such as double tee flanges, slabs, wall panels. Conventional methods use a blockout to both maintain positioning of the flange connector and protect the edges of the flange connector. Such conventional blackouts are made of plastic.

For a precast plant, the plastic blockout and flange connector are positioned on and secured to a steel side rail of a structure. Conventional attachment methods have a number of disadvantages including, the methods are time consuming and subject users to a difficult assembly process. Specifically, conventional methods require users to drill holes into the side form, the blockout, and the flange connector, align the holes and drive bolts through the holes of the side form, the blockout, and the flange connector. The bolts are then screwed onto wing nuts, and tightened for secure coupling. In order to maneuver the bolts through the holes, users are required to bend or squat down repeatedly while maintaining alignment of the holes, which can become quite burdensome.

Aside from being time consuming, conventional attachment methods are also expensive, reduce the life of the form, and do not allow flexibility in locating the blockout or flange connector after the holes are drilled.

### SUMMARY OF THE INVENTION

The present general inventive concept provides a flange connector block out magnet that is inexpensive, easy to assemble, and has a long lifespan.

The present general inventive concept also provides a blockout magnet with a magnetic void that fits around a flange connector for use in aligning and protecting a surface of the flange connector from foreign substances, such as concrete.

The foregoing and other objects are intended to be illustrative of the general inventive concept and are not meant in a limiting sense. Many possible embodiments of the general inventive concept may be made and will be readily evident upon a study of the following specification and accompanying drawings comprising a part thereof. Various features and subcombinations of the general inventive concept may be employed without reference to other features and subcombinations. Other objects and advantages of this general inventive concept will become apparent from the following description taken in connection with the accompanying drawings, wherein is set forth by way of illustration and example, an embodiment of this general inventive concept and various features thereof.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates an exemplary embodiment of the present general inventive concept illustrating a front, a rear, and two side edges of a magnetic blockout.

FIG. 2 illustrates the present general inventive concept of FIG. 1 illustrating the front, the rear, and a bottom edge of the magnetic blockout.

FIG. 3 illustrates the present general inventive concept of FIG. 1 illustrating the front and rear of the magnetic blockout.

FIG. 4 illustrates the present general inventive concept of FIG. 1 illustrating a flange connector attached to the front face of the magnetic blockout.

FIG. 5 illustrates the present general inventive concept of FIG. 1 illustrating a flange connector attached to the front face of the magnetic blockout.

FIG. 6 illustrates the present general inventive concept of FIG. 1 illustrating a flange connector attached to the front face of the magnetic blockout.

FIG. 7 illustrates the present general inventive concept of FIG. 1 illustrating a flange connector attached to the front face of the magnetic blockout.

FIG. 8 illustrates the present general inventive concept of FIG. 1 illustrating a flange connector attached to the front face of the magnetic blockout.

FIG. 9 illustrates the present general inventive concept of FIG. 1 illustrating a flange connector attached to the front face of the magnetic blockout.

FIG. 10 illustrates the present general inventive concept of FIG. 1 illustrating the magnetic blockout and various features including pre-threaded holes and a void for the flange connector.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept be referring to the figures.

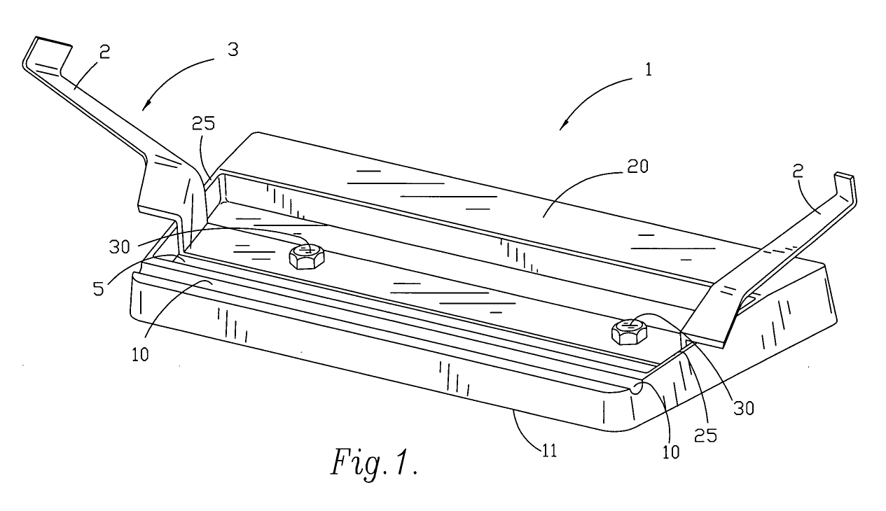

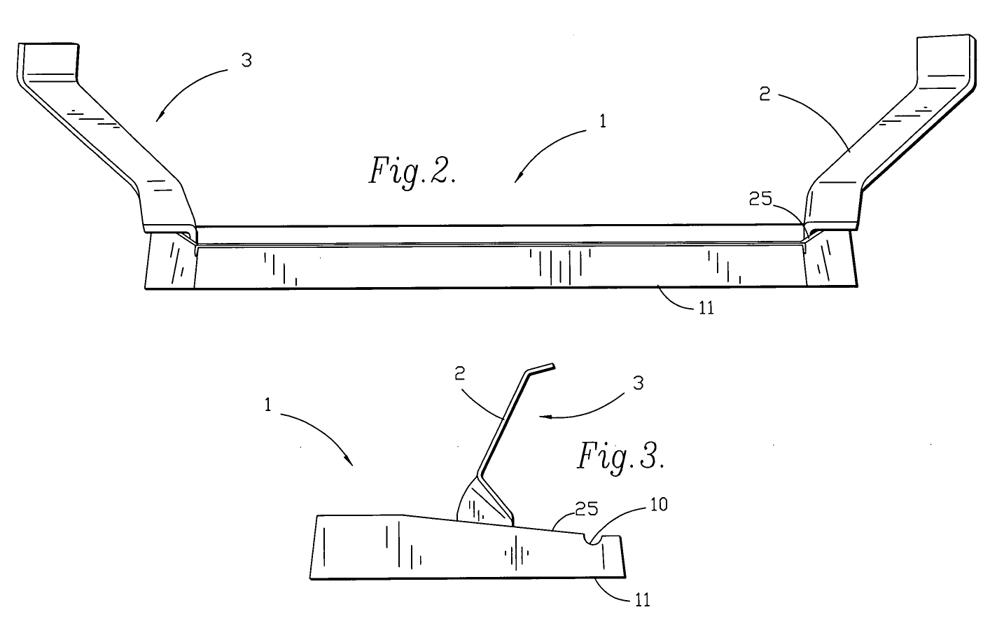

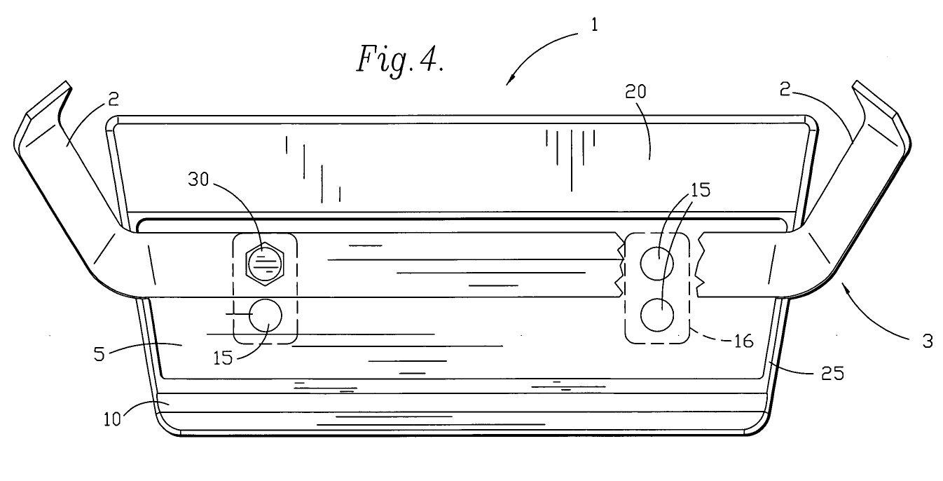

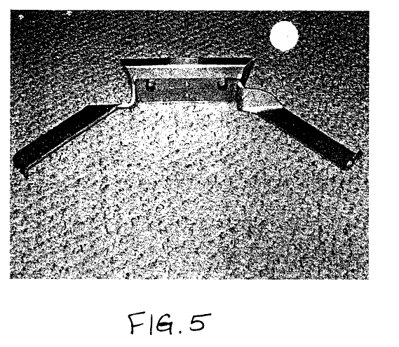

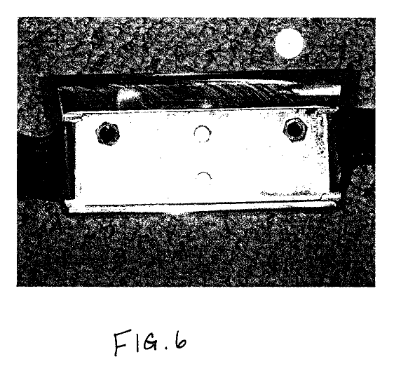

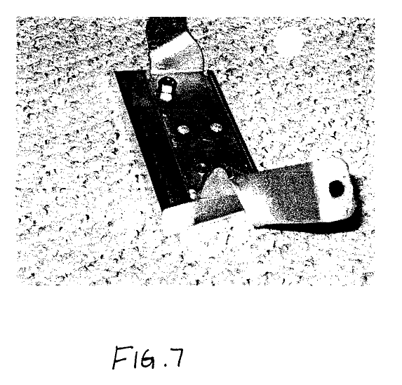

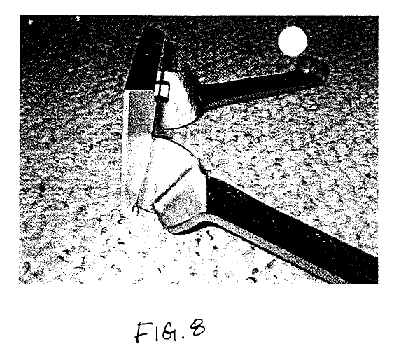

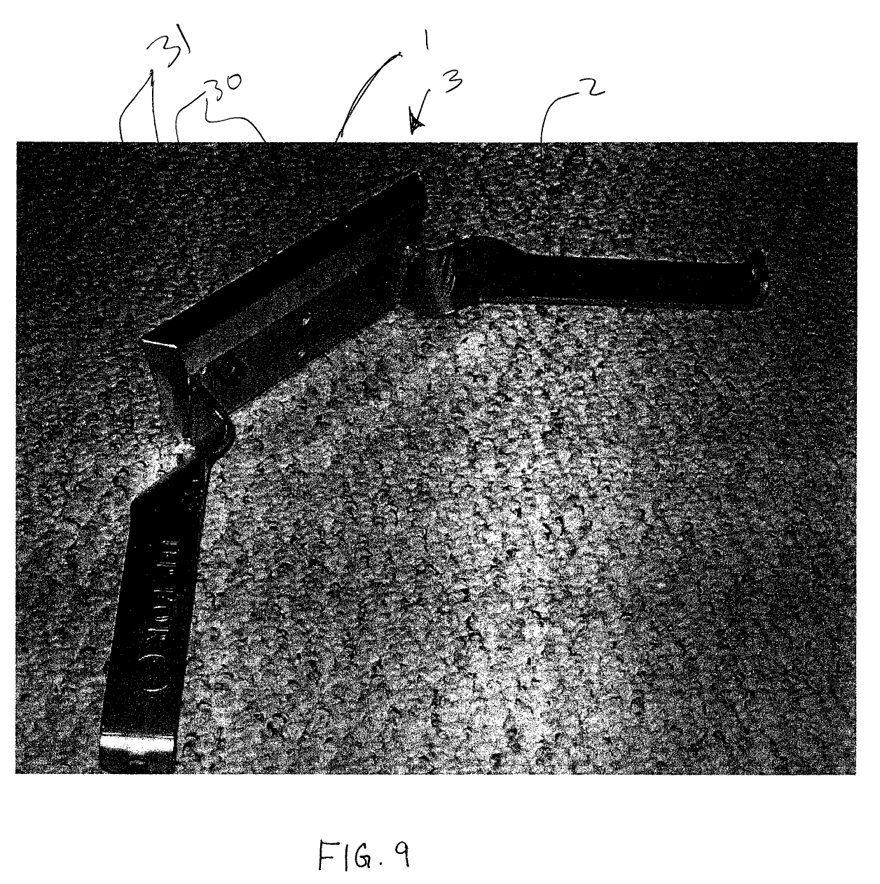

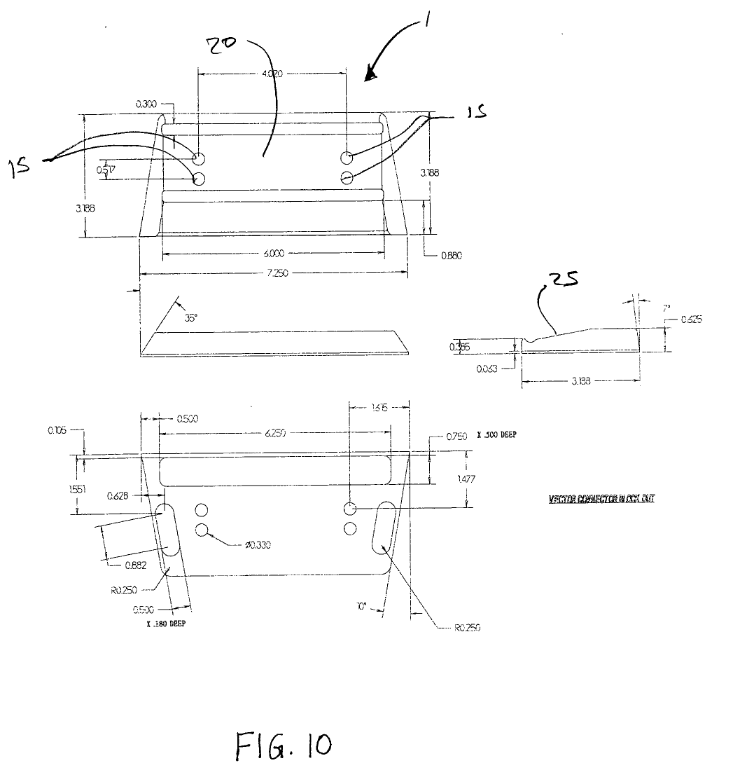

FIG. 1 illustrates a blockout magnet 1, which can be made of aluminum, steel, plastic, urethane, or other like material. The magnetic blockout 1 forms around a flange connector profile 2 allowing the flange connector 2 to nest slightly a void 5 on a front side 10 of the magnetic blockout 1, thereby creating a concrete barrier around a surface of the flange connector 2. The void 5 also facilitates secure engagement of the magnetic blockout 1 and the flange connector 2. In the exemplary embodiment, the magnetic blockout 1 is manufactured from a single piece of material. Pre-tapped holes 15 extend through the magnetic blockout 1 extending from a front side 10 to a back side 11. One or more of the holes 15 are situated in a one or more recesses 16 on the back side 11 of the magnetic block out 1.

At least one magnet 20 is embedded within or attached to the magnetic blockout 1, preferably within the back side 11 of the magnetic blockout 1. In the exemplary embodiment, the magnetic blockout 1 has a slight slope 25 on the front side 10 of the magnetic blockout 1 opposite to the back side 11 with the magnet 20 to provide access to the flange connector 2 during use.

In the exemplary embodiment, the magnetic blockout 1 and flange connector 2 are coupled by placing the flange connector 2 inside the void 5 of the magnetic blockout 1 to form an assembly 3. The magnetic blockout 1 may be secured to the flange connector 2 by one or more fasteners 30, and wing nuts 31. The fastener 30 is preferably a bolt with no head to permit removal of the fastener 30 from either the front side 10 or the back side 11 of the magnetic blockout 1 without need to access the other side.

An Allen Wrench or screwdriver may be used to drive the fasteners 30 through the pre-threaded holes 15 in the magnetic blockout 1 and secured thereto with the wing nuts 31. The fasteners 30 or wing nuts 31 are wholly contained within the recesses 16 so as to be flush with the back side 11 and not interfere with the magnet 20.

In use, the assembly 3 is placed on a side rail (not illustrated) in the desired location. The magnet 20 on the back side 11 of the magnetic blockout 1 magnetically secures the assembly 3 onto the side form. Concrete is then poured into the steel mold or form to surround the magnetic blockout 1 and the flange connector 2. After the concrete has cured, the fasteners 30 are removed and the final concrete slab is stripped from the form. The magnetic blockout 1 is then removed from the flange connector 2 to reveal a clean area around the flange connector 2.

The slight slope 25 provides access to the flange connector 2 for welding during maneuvering of the side form, e.g., erection of the side form. After stripping, the fasteners 30 are removed from the back side 11 of the magnetic blockout 1 and the magnetic blockout 1 is pulled away from the flange connector 2 that remains embedded in concrete.

The present general inventive concept and attachment method may be assembled easier and in less time because users are not required to repeated bend and/or squat to maneuver bolts through holes to attach the assembly 3 to side forms. Further, drilled holes are not required in the side form, thus providing a simpler process and a side form with an increased structural integrity and life span. Still further, the present general inventive concept and attachment method provides increased versatility with respect to locating the blockout and the flange connector.

In another preferred embodiment, a user may employ a plastic expansion pin (not illustrated) to attach the magnetic blockout 1 to the flange connector 2. A procedure similar to aforementioned process is used except instead of threading and tightening using the wing nuts 31, the plastic expansion pin is inserted through the holes 15 and an expanding end of the pin secures the magnetic blockout 1 to the flange connector 2.

Having now described the features, discoveries and principles of the general inventive concept, the manner in which the general inventive concept is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the general inventive concept herein described, and all statements of the scope of the general inventive concept which, as a matter of language, might be said to fall therebetween.

What is claimed is:

1. A magnetic blockout assembly comprising:
a concrete barrier element having a front side, a back side and a cavity in the front side;
at least one magnet embedded within the back side of the concrete barrier element; and
a flange connector having an engagement surface sized and shaped to fit within the cavity of the concrete barrier element.

2. The magnetic blockout assembly according to claim 1, further comprising:
one or more holes passing from the front side of the concrete barrier element to the back side of the concrete barrier element; and
one or more holes in the flange connector,
wherein the one or more holes in the concrete barrier element correspond to the one or more holes in the flange connector to allow one or more couplers to pass therethrough to couple the concrete barrier element to the flange connector.

3. The magnetic blockout assembly according to claim 2, further comprising:
one or more recesses in the back side of the concrete barrier element to allow the couplers to nest entirely within the concrete barrier element and not interfere with the at least one magnet.

4. The magnetic blockout assembly according to claim 1, further comprising:
a slope on the front side of the concrete barrier element to provide access to the flange connector.
a plurality of outer plates, one on either side of the connection layer,
wherein the plurality of connection layers join the first and second magnetic portions to the plurality of outer plates.

5. The magnetic blockout assembly according to claim 5, wherein the front side of the concrete barrier element defines a magnetic focal direction.

6. The magnetic blockout assembly according to claim 5, wherein the front side of the concrete barrier element provides a buffer zone between the at least one magnet and the flange connector.

7. A method of using a magnetic blockout assembly comprising:
providing a concrete barrier element having a front surface and a back surface with a concrete barrier element aperture therethrough;
providing a flange connector having a flange connector aperture sized and shaped to correspond with the concrete barrier element aperture;
providing at least one magnet located on the concrete barrier element back surface;
coupling the concrete barrier element to the flange connector with a device connector so that a front end of the device connector nests inside of the concrete barrier element;
attaching the concrete barrier element back surface to a construction element to position the flange connector in a predetermined location;
pouring concrete around the concrete barrier element and flange connector; and
removing the concrete barrier element to yield a concrete-free surface.
